(19) United States
(12) Patent Application Publication
(10) Pub. No.: US 2011/0247191 A1
(43) Pub. Date: Oct. 13, 2011

(54) Method for making holders for cylindrical dispensing containers

(76) Inventor: Matthew Charles Koziol, Wethersfield, CT (US)

(21) Appl. No.: 12/798,663

(22) Filed: Apr. 8, 2010

(51) Int. Cl. B23P 19/00

(52) U.S. Cl. 29/428

(57) ABSTRACT

A plurality of identical first parts comprise back, bottom and front wire members formed integrally in a generally U-shape. A plurality of second parts comprise identical flat plates for interconnecting a pair of the first parts. When interconnected by welding together a pair of the first and a pair of the second parts a CYLINDRICAL CONTAINER HOLDER is provided in a most economical method of manufacture.

A wide variety of holders for dispensing and other types of containers are available in the prior art.

The present invention has as its general object the provision of a method of manufacturer requiring only multiples of two different parts to provide any desired number of holders which are efficient and durable in use and which can be manufactured at substantial economic advantage.

### SUMMARY OF THE INVENTION

In accordance with the present invention and in fulfillment of the foregoing object, a plurality of identical first parts and a plurality of different identical second parts are provided. Each holder for cylindrical containers requires only two of each of the two different parts. Each first part has a narrow elongated vertically extending rear member, a narrow elongated bottom member formed integrally at a rear end portion with a lower end portion of the rear member and extending forwardly in a substantially horizontal direction. A narrow elongated front member formed integrally at its lower end portion with a front end portion of said bottom member extends upwardly in a generally vertical direction with an upper end portion comprising a means adapted to grip and frictionally retain a cylindrical container in cooperation with said elongated rear member. Two identical second parts of the holder take the form of a substantially flat mounting plate adapted at opposite parallel sides for selective connection with said rear vertical members and said horizontal bottom members of said two first parts. Further, in accordance with the method of the invention, the two identical first parts are positioned in spaced apart parallel relationship and like attitudes. The opposite sides of a first one of said second parts is connected with said parallel rear members of said two first parts and the opposite sides of the other of said second parts is connected with said parallel bottom members of said two first parts.

Preferably the first and second parts are metallic and are welded together with small end covers of a relatively soft material placed over the free ends of the front members of each first part. Also, in preferred form, each front member of each first part is provided with a slightly rearwardly inclined upper end portion to retain a container frictionally against inadvertent upward movement.

Each second part is provided with at least one opening for attachment of the part to an adjacent wall, counter, or other surface with each opening, preferably adapted for a dual function. That is, the size and shape of the openings is such that fasteners such as screws may be used selectively as well as suction cups with their rear mounting portions captured in the openings. A variety of other fastening devices may also bee employed.

### DESCRIPTION OF THE DRAWINGS

FIG. 1 of the drawings is a perspective view showing a container holder manufactured in accordance with the method of the invention.

FIG. 2 is an exploded perspective view of the holder of FIG. 1.

FIG. 3 Is a perspective view of the holder with a dispensing container mounted therein.

FIG. 4 is a side view of the holder with a dispensing container mounted therein.

### DESCRIPTION OF PREFERRED EMBODIMENTS

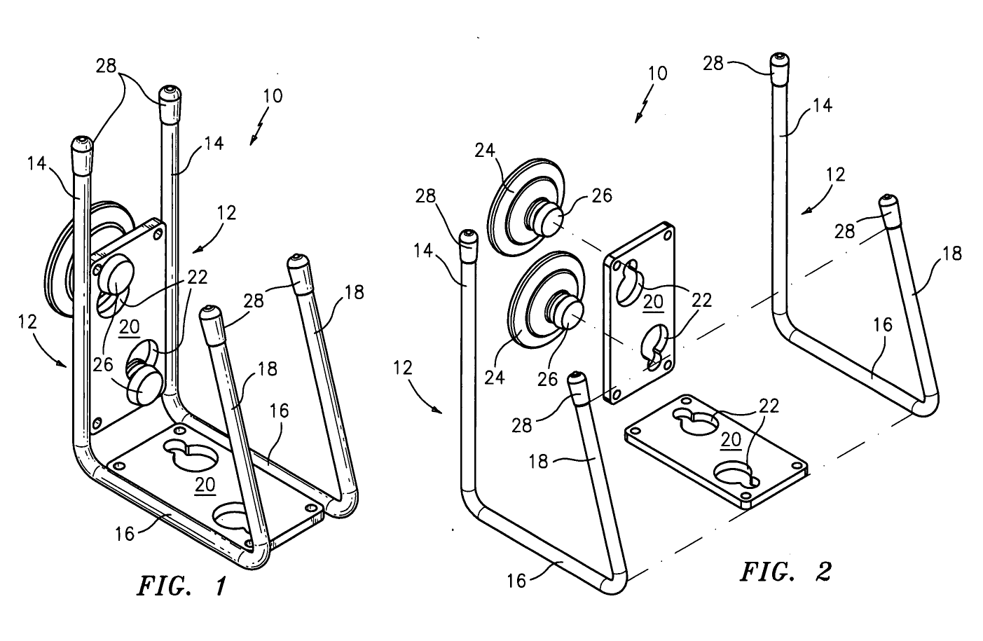

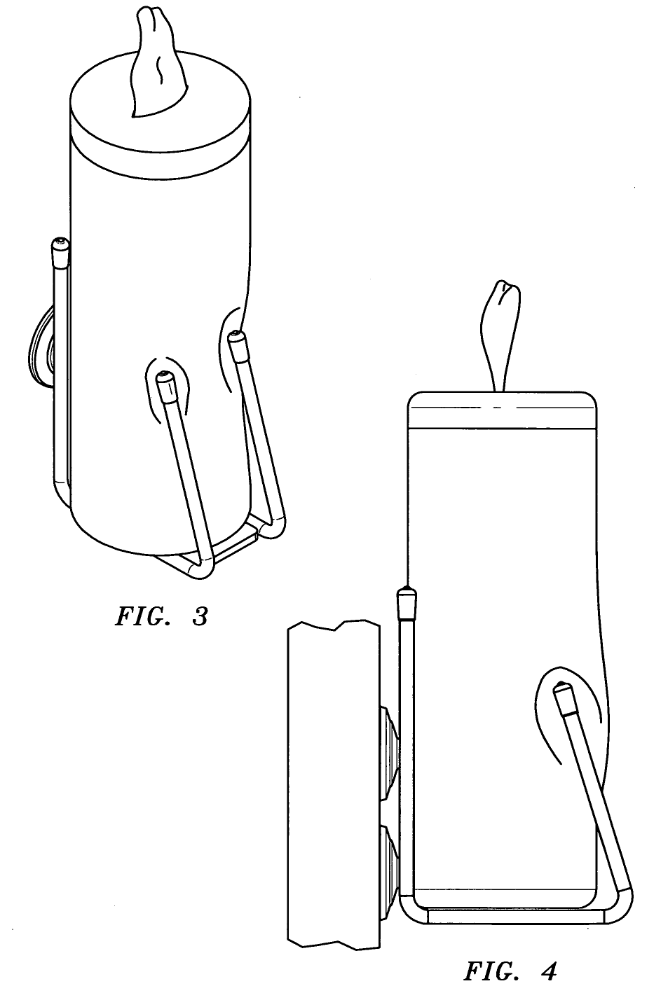

Referring particularly to FIGS. 1 and 2, a holder constructed in accordance with the method of the invention is indicated generally by the reference numeral 10. A pair of identical first parts of the holder 12, 12 are shown with each part comprising a narrow elongated vertically extending rear member 14, a narrow elongated bottom member 16, formed integrally at a rear end portion with a lower end portion of the rear member 14 and extending forwardly in a substantially horizontal direction. Formed integrally with the bottom portion at its lower end portion is a narrow elongated front member 18 which extends upwardly in a generally vertical direction with a rearwardly inclined upper end portion comprising means adapted to grip and frictionally retain a cylindrical dispensing or other container in cooperation with a elongated rear member 14.

Identical second parts 20, 20 take the form of substantially flat mounting plates adapted at opposite parallel sides for connection with rear vertical members 14, 14 and horizontal bottom members 16, 16.

In accordance with the method of the invention, a pair of first parts 12, 12 are positioned in parallel relationship and in like attitude as illustrated in FIG. 2. The opposite sides of one of the second parts 20, 20 are then connected by welding or otherwise between the rear members 14, 14 of the first parts 12, 12 and a second part 20 is similarly connected between the bottom members 16, 16 of the two first parts whereupon assembly is essentially complete. Screws, not shown, may be employed through openings 22, 22 in the plates to affix the holder to adjacent vertical of horizontal surfaces. Alternatively, suction-type mounting devices 24, 24 may be employed with rear end portions 26 thereof entered in the openings 22, 22.

Finally, small end covers 28, 28 may be provided at upper end portions of rear and front members for ease in insertion of the dispensing container.

As will be apparent from the forgoing, the method of the present invention provides for a minimum of parts and a very simple and expedient assembly of the parts resulting in an overall manufacturing procedure at economic advantage.

1. A method for making a holder for cylindrical containers and the like which requires only two of each of two different parts and which may therefore be practiced at substantial economic advantage; said method comprising the step of providing two identical first parts each having a narrow elongated vertically extending rear member, a narrow elongated bottom member formed integrally at a rear end portion with a lower end portion of said rear member and extending forwardly in a substantially horizontal direction, and a narrow elongated front member formed integrally at its lower end portion with a front end portion of said bottom member and extending upwardly in a generally vertical direction and comprising means adapted to retain a cylindrical container in cooperation with said elongated rear member, providing two identical second parts each in the form of a substantially flat mounting plate adapted at opposite parallel sides for connection with said rear vertical members and said horizontal bottom members of said two first parts, positioning said two first parts in spaced apart parallel relationship and like attitudes, connecting the opposite sides of a first one of said second parts with said parallel rear members of said two first parts, and connecting the opposite sides of the other of said second parts with said parallel bottom members of said two first parts.

2. A method as set forth in claim 1 wherein the first and second parts are welded together.

3. A method as set forth in claim 1 wherein small end covers of a relatively soft material and with a smooth outer surface are provided and are placed at least over the free ends of the front members of each first part.

4. A method as set forth in claim 1 wherein the container is of the dispensing type with individual elements pulled sequentially upwardly from an opening in its top surface, and wherein the front member of each first part is provided with a rearwardly inclined upper end portion to frictionally restrain the container against inadvertent upward movement.

5. A method as set forth in claim 1 wherein each of the second parts is provided with at least one opening for attachment of the part to an adjacent surface.

6. A method as set forth in claim 5 wherein each opening is adapted for at least two functions in connection to the adjacent surface, the size of the openings being such that fasteners such as screws may be used selectively as well as suction cups with rear mounting portions captured in the openings.

7. A method as set forth in claim 1 wherein the holder is of metallic construction.

8. A method as set forth in claim 1 wherein the holder is of thermo-plastic construction.
